(19) United States
(12) Patent Application Publication
(10) Pub. No.: US 2012/0092949 A1
(43) Pub. Date: Apr. 19, 2012

(54) SYNCHRONIZED MIXING DEVICE AND METHOD

(75) Inventors: Michael Joseph Preston, Churchville, NY (US); Thomas A. Dziekonski, Avon, NY (US)

(73) Assignee: SPX Corporation, Charlotte, NC (US)

(21) Appl. No.: 13/100,875

(22) Filed: May 4, 2011

Related U.S. Application Data
(60) Provisional application No. 61/392,572, filed on Oct. 13, 2010.

(51) Int. Cl. B01F 3/14; B01F 13/00; B01F 15/00

(52) U.S. Cl. 366/142; 366/341

(57) ABSTRACT

A system for mixing a fluid in a tank includes a set of mixers and a controller. The set of mixers is disposed proximal to a perimeter of the tank. The set of mixers are operable to pivot. The controller is configured to control the set of mixers to pivot from a first orientation to a second orientation. The controller is configured to control each mixer of the set of mixers to stop pivoting in a first direction in response to each respective mixer achieving a predetermined intermediate orientation and the controller is configured to control the set of mixers to continue pivoting in the first direction in response to all mixers of the set of mixers achieving the predetermined intermediate orientation.

### CROSS-REFERENCE TO RELATED APPLICATIONS

This application claims priority to U.S. Provisional Patent Application entitled, SYNCHRONIZED MIXING DEVICE AND METHOD, filed Oct. 13, 2010, having a Ser. No. 61/392,572, the disclosure of which is hereby incorporated by reference in its entirety.

### FIELD OF THE INVENTION

The present invention generally relates to a mixing device and method. More particularly, the present invention pertains to a device and method for mixing a fluid disposed in a tank.

### BACKGROUND OF THE INVENTION

It is generally known that fluids stored in tanks will often settle. Settling of some fluid may be of no consequence or even desirable. However, in other fluid, settling may be detrimental. For example, in petroleum product, settling may cause basic components to precipitate or concentrate at or near the bottom of the tank—damaging the tank and reducing the quality of the petroleum product stored therein. In general, this problem is referred to as bottom sediment and water (BS&W).

Mixers are typically used to reduce or eliminate settling. However, it is difficult for mixers to thoroughly mix fluids stored in large tanks without “dead zones” of slow moving or stagnant fluid. While a variety of conventional techniques have been employed to attempt to reduce or eliminate these dead zones, these conventional methods are labor intensive and prone to catastrophic failures.

Accordingly, it is desirable to provide a system, device and method capable of overcoming the disadvantages described herein at least to some extent.

### SUMMARY OF THE INVENTION

The foregoing needs are met, to a great extent, by the present invention, wherein various respects a system, device, and method of mixing fluid in a tank is provided.

An embodiment of the present invention pertains to a system for mixing a fluid in a tank. The system includes a set of mixers and a controller. The set of mixers is disposed proximal to a perimeter of the tank. The set of mixers are operable to pivot. The controller is configured to control the set of mixers to pivot from a first orientation to a second orientation. The controller is configured to control each mixer of the set of mixers to stop pivoting in a first direction in response to each respective mixer achieving a predetermined intermediate orientation and the controller is configured to control the set of mixers to continue pivoting in the first direction in response to all mixers of the set of mixers achieving the predetermined intermediate orientation.

Another embodiment of the present invention relates to a method of synchronizing an orientation of a plurality of mixers in a tank. In this method, the plurality of mixers are controlled to pivot in a first direction, each mixer of the plurality of mixers is stopped from pivoting in response to the respective mixer achieving a predetermined intermediate orientation, and the plurality of mixers are controlled to continue pivoting in the first direction in response to the plurality of mixers achieving the predetermined intermediate orientation.

In yet another embodiment, a mixing apparatus for use with a vessel is provided, comprising: at least one mixer disposed proximal to a perimeter of the tank, said at least one mixer being operable to pivot or translate between a first position and a second position; an actuator assembly connected to said at least one mixer, wherein said actuator operates to translate or pivot said at least one mixer between said first position and said second position; a controller configured to control said actuator, wherein said controller operates to control translation of said at least one mixer between said first position and said second position.

In still another embodiment of the present invention, A method of translating or pivoting at least one mixer in a vessel, is provided comprising the steps of: sending a position command from a control to an actuator assembly connected to the at least one mixer; and translating the at least mixer from a first position to a second position in response to the position signal.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a diagram of a tank mixing system according to an embodiment of the invention.

FIG. 2 is a diagram of an orientation of mixers suitable for the system of FIG. 1.

FIG. 3 is a diagram of a predetermined intermediate orientation of mixers suitable for the system of FIG. 1.

FIG. 4 is a diagram of a second orientation of mixers suitable for the system of FIG. 1.

FIG. 5 is a top view of an actuator assembly in a mixer suitable for the system of FIG. 1.

FIG. 6 is a side view of the actuator assembly in the mixer suitable for the system of FIG. 1.

FIG. 7 is a block diagram of a system architecture for the tank mixing system of FIG. 1.

### DETAILED DESCRIPTION

The present invention provides tank mixing system, pivot assembly, and system of controlling the tank mixing system to mix fluid in a tank. For the purposes of this disclosure, the term “tank” and variations thereof refer to a container or vessel of any suitable size or shape and to contain any suitable fluid. In a particular example, the tank or tanks described herein may be suitable for containing many tens, hundreds, thousands, millions etc. of liters of fluid. In a specific example, the fluid may be a petroleum product stored in a tank having a relatively large volume such as, hundreds to millions of barrels.

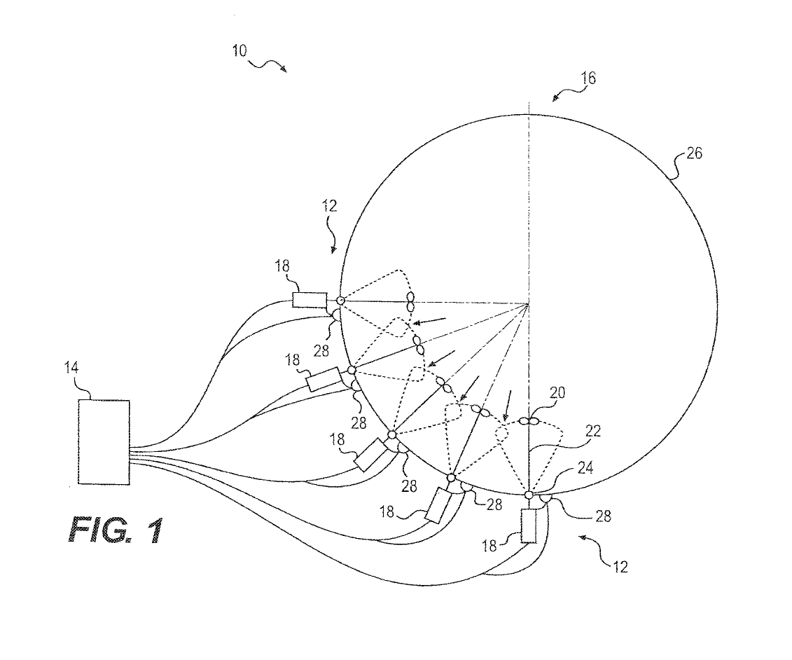

FIG. 1 is a diagram of a tank mixing system 10 according to an embodiment of the invention. As shown in FIG. 1, the tank system 10 includes one or more mixers 12 controlled via a controller 14. The mixers 12 are disposed upon a tank 16. In general, the mixers 12 include a motor portion 18 disposed outside the tank 16 and an impeller portion 20 disposed inside the tank 16. A shaft 22 connects the motor portion 18 to the impeller portion 18. The mixers 12 include a seal 24 to allow the shaft 22 to pass through a wall 26 of the tank 16.

The seal 24 is configured to allow the shaft 22 to rotate while providing an essentially fluid tight seal—thereby preventing or reducing leakage of the fluid contents from the tank 16. In an embodiment of the invention, the seal 24 allows the shaft 22 to pivot relative to the wall 26. This pivoting action facilitates changing the orientation of the mixers 12. In this manner, precipitate that develops in one orientation may be swept clean and/or re-suspended by reorienting the mixers 12.

To pivot the mixers 12, some or all of the mixers 12 may include an actuator assembly 28. If included, the actuator assembly 28 is configured to urge the respective mixer 12 to pivot. The actuator assembly 28 may include any suitable actuating device such as, for example, motor, pneumatic or hydraulic actuators, linear thruster or other such device. In a particular example, the actuator assembly includes a motor configured to rotate a worm gear or threaded rod.

Pivoting the mixers 12 reduces or eliminates sediment, however, this pivoting action may allow the impeller portion 20 of one mixer 12 to interact with the impeller portion 20 and or shaft 22 of another mixer 12. Such interactions may cause damage to one or both of the mixers 12. As disclosed herein, embodiments of the invention reduce or eliminate such interactions when pivoting the mixers 12 from a first to a second orientation by moving some or all the mixers 12 to a predetermined intermediate orientation. Once the mixers 12 have achieved the predetermined intermediate orientation, the mixers 12 may be controlled to pivot towards the second orientation or a second predetermined intermediate orientation.

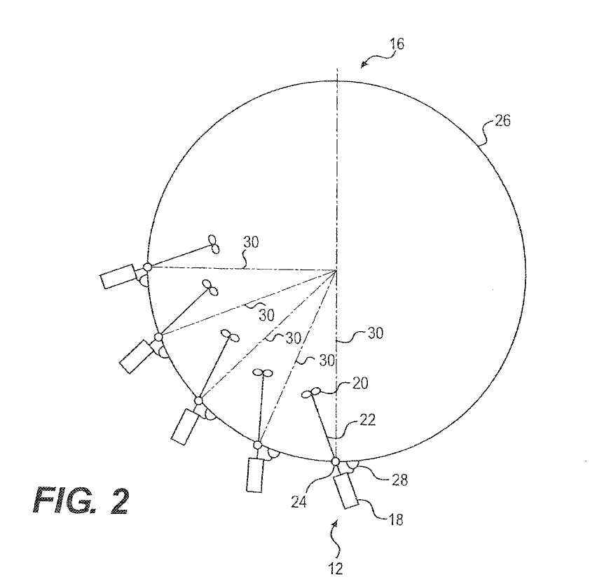

FIG. 2 is a diagram of an orientation of the mixers 12 suitable for the mixer system 10 of FIG. 1. As shown in FIG. 2, the mixers 12 are canted or pivoted about 30° from a line passing through the center of the tank 16 and the respective seal 24. In another example, the mixers 12 are pivoted relative to a line perpendicular to the tangent at the respective seal 24. For the purposes of this disclosure, this line shall be referred to as a normal line 30. By pivoting the mixers away from the normal line 30, a circular or clockwise flow pattern may be developed within the fluid that reduces settling.

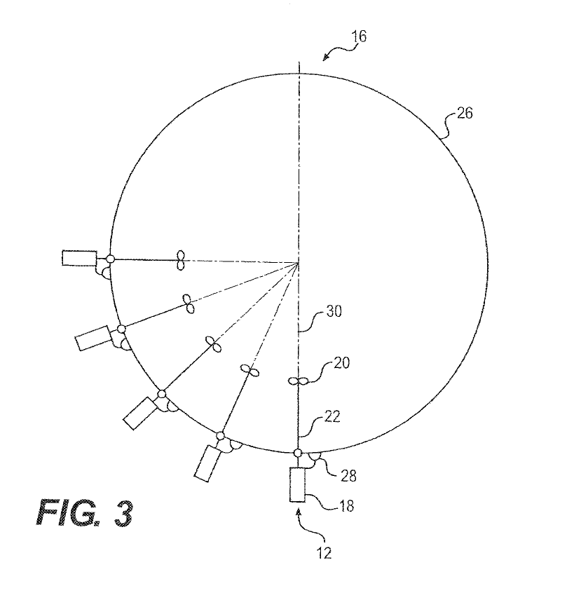

FIG. 3 is a diagram of a predetermined intermediate orientation of the mixers 12 suitable for the mixing system 10 of FIG. 1. As shown in FIG. 3, all of the mixers 12 have been oriented along their respective normal lines 30. In the particular embodiment shown, bringing the mixers 12 to the normal line 30 does not allow any one mixer 12 to cross a path or otherwise interact with any other mixer 12. Once all the mixers 12 have oriented along their respective normal lines 30, the mixers 12 may be urged to the second position.

In other embodiments, there may be a plurality of predetermined intermediate positions. For example, if the shafts 22 were longer, the spacing of the mixers 12 closer, the pivot of the mixers greater, and/or the impeller portion larger in diameter, two or more predetermined intermediate positions may be utilized to prevent or reduce interaction of the mixers 12. In a particular example, the first predetermined intermediate orientation may be about 10° from the normal line 30 and the second predetermined intermediate position may be about −10° from the normal line 30

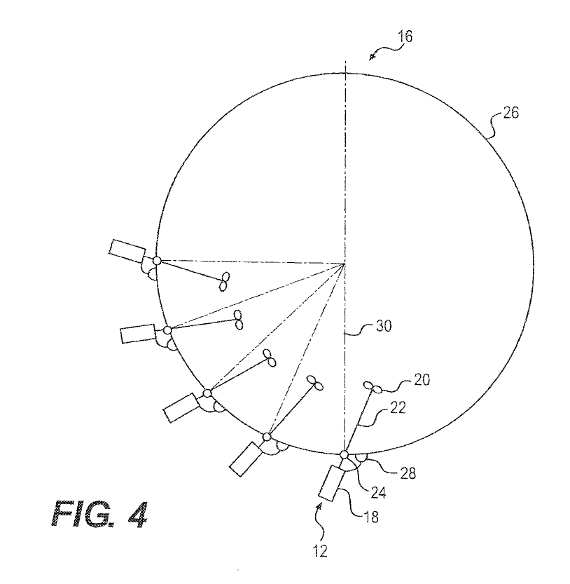

FIG. 4 is a diagram of a second orientation of mixers 12 suitable for the mixing system 10 of FIG. 1. As shown in FIG. 4, the mixers 12 have been urged to the second orientation suitable for generating a generally counterclockwise flow of the fluid within the tank 16.

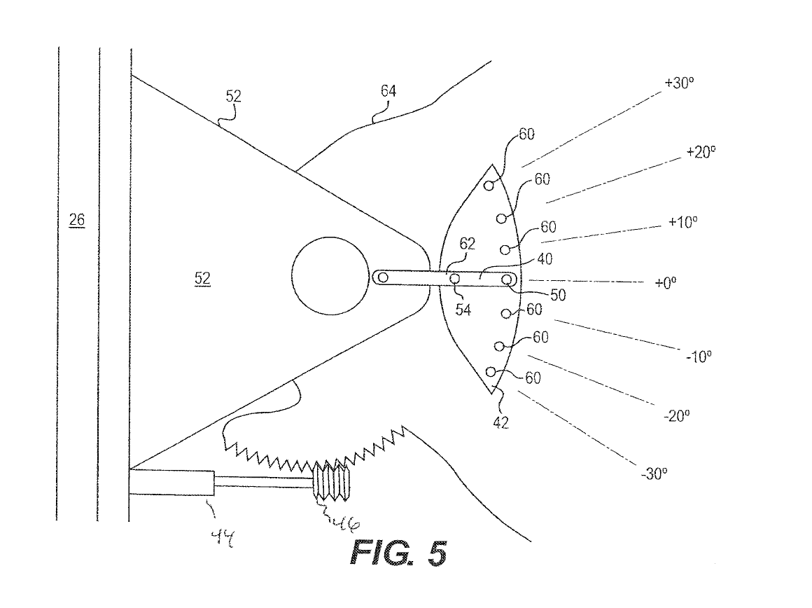

FIG. 5 is a top view of an exemplary actuator assembly 28 in a mixer suitable for mixer the system 10 of FIG. 1. As shown in FIG. 5, the actuator assembly 28 includes a pickup sensor arm 40, sensor plate 42, motor 44, worm gear 46, and sprocket 48. The pickup sensor arm 40 includes a sensor 50 and is fixed upon a flange 52 that is mounted on the wall 26. The pickup sensor arm 40 is configured to remain stationary relative to the tank 16 while the mixer 12 pivots. Optionally, the pickup sensor arm 40 includes a predetermined intermediate orientation sensor 54. If included, the predetermined intermediate orientation sensor 54 is configured to sense when the mixer 12 is in the predetermined intermediate orientation. As previously discussed, the present invention encompasses alternative means for actuation, for example, actuator assembly may include any suitable actuating device such as, for example, motor, pneumatic or hydraulic actuators, linear thruster or other such device.

The sensor plate 42 includes a plurality of indicators 60. The indicators 60 are configured to be sensed by the sensor 50 and/or 54. In a particular example, the indicators 60 include magnets and the sensor 50 and/or 54 are configured to sense when a magnet is disposed in cooperative alignment. The sensor plate 42 optionally includes a predetermined intermediate orientation indicator 62. If included, the predetermined intermediate orientation indicator 62 is configured to indicate that the predetermined intermediate orientation has been achieved.

The motor 44 is configured to rotate the worm gear 46 and thereby urge the sprocket 48 to rotate. The motor 44 is fixed upon the flange 52 and the sprocket 48 is fixed upon a swivel 64. The motor portion 18 of the mixer 12 is secured to the swivel 64. In this manner, the mixer 12 may be pivoted relative to the tank wall 26. The sensor plate 42 is fixed to the swivel 64 and thus moves or rotates relative to the pickup sensor arm 40.

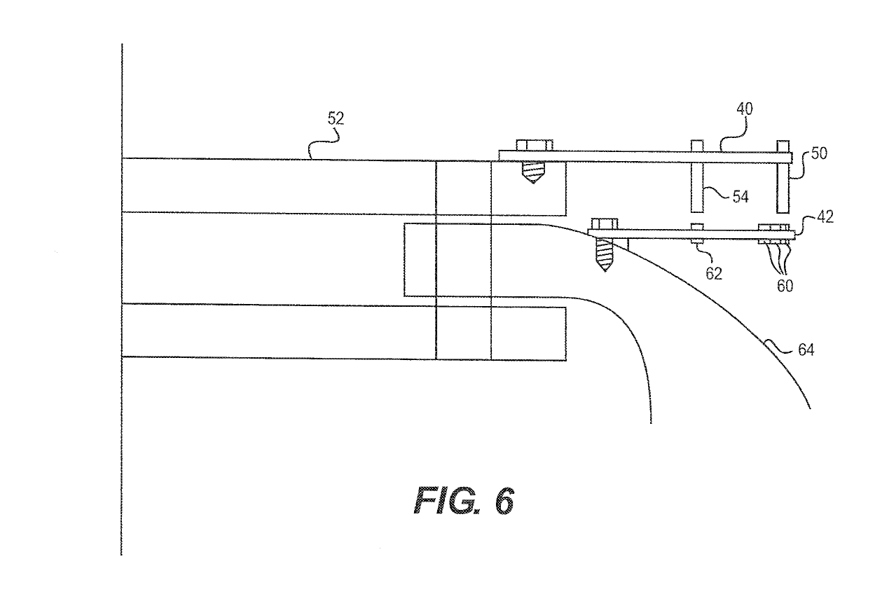

FIG. 6 is a side view of the actuator assembly 28 in the mixer 12 suitable for the mixer system 10 of FIG. 1. As shown in FIG. 6, by the sensor 50 and/or 54 and the indicators 60 and/or 62 are configured to align cooperatively at respective orientations of the mixer 12. That is, for example, at a nominal orientation, the predetermined intermediate orientation sensor 54 and the predetermined intermediate orientation indicator 62 are configured to align such that the predetermined intermediate orientation sensor 54 is configured to sense the predetermined intermediate orientation indicator 62. In response to sensing the predetermined intermediate orientation indicator 62, a signal is forwarded to the controller 14.

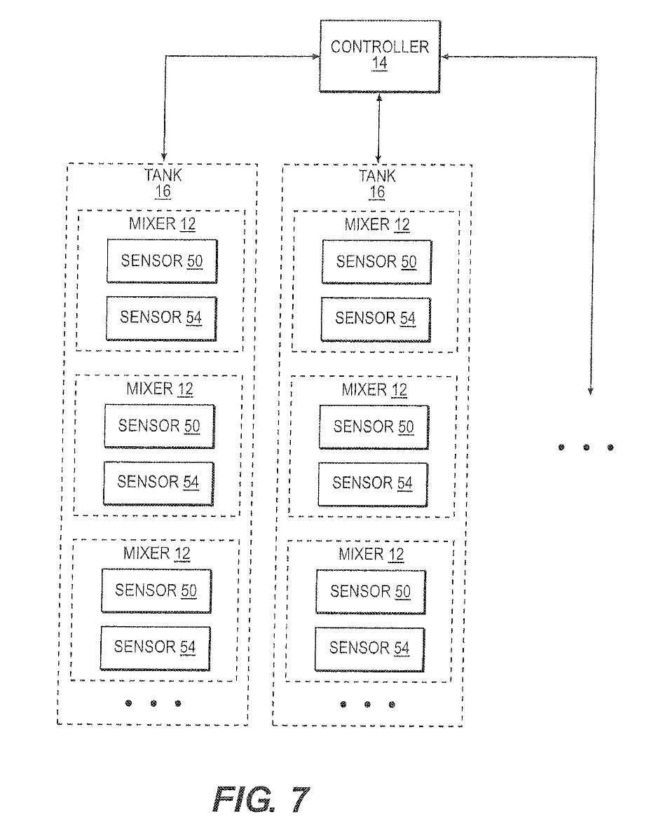

FIG. 7 is a block diagram of a system architecture for the tank mixing system 10 of FIG. 1. As shown in FIG. 7, the controller 14 is operable to receive signals from and send signals to the sensor 50 and/or 54 of one or more of the mixer(s) 12 of one or more of the tank(s) 16. In this manner, a single controller 14 may be operable to control the mixing of a plurality of tanks 16. Also shown in FIG. 7, the tank mixing system 10 may include a user interface 70 configured to send signals to and receive signals from the controller 14 via a network 72 for example The user interface 70 and or controller 14 may further include a processor, memory, and the like configured to execute and/or store computer readable code. This computer readable code may be utilized to store instructions for performing a method of mixing fluids in the tanks 16. In addition, the controller is configured to send power to selected mixers 16 and/or control the direction of the pivot.

To perform the method from a first orientation as shown in FIG. 2, the controller 14 is configured to control the mixers 12 to pivot clockwise. In response to each mixer 12 achieving the predetermined intermediate orientation (e.g., a nominal orientation), the controller 14 is configured to stop the respective mixer 12 from pivoting. In a particular example, it is determined that the predetermined intermediate orientation has been achieved in response to the predetermined intermediate orientation sensor 54 forwarding a signal to the controller that the predetermined intermediate orientation indicator 62 has been sensed. Once all mixers 12 have achieved the predetermined intermediate orientation (shown in FIG. 3), the controller 14 is configured to control the mixers 12 to begin pivoting clockwise again until the second orientation is achieved. In this regard, the controller 14 may monitor the progress of each mixer 12 based on the number of sensed indicators 60. Using the sensor plate 42 shown in FIG. 5 as a particular example, the controller 14 may be configured to determine that the mixer 12 has achieved 10° in response to a first indicator 60 being sensed. In some embodiments, the controller 14 may be configured to stop or pause each mixer 12 until all mixers 12 have achieved 10° before controlling the mixers 12 to continue pivoting. Thereafter, the controller 14 may be configured to determine that the mixer 12 has achieved 20° in response to a next indicator 60 being sensed. In this manner, the movement of the mixers 12 may be synchronized to prevent or reduce interactions of the impeller portions of the mixers 12 with one another.

In other embodiments, the orientations of the mixers 12 in a tank 16 may be relatively different from one another. For example, in a first orientation, a first mixer 12 may be controlled to orient at the nominal angle, a second mixer 12 may be controlled to orient at +10°, a third mixer 12 may be controlled to orient at +20°, etc. Following a predetermined elapsed amount of time mixing at the first orientation, the controller 14 may be configured to orient all the mixers 12 at the predetermined intermediate orientation (the nominal orientation, for example). In response to all mixers achieving the predetermined intermediate orientation, the controller 14 may be configured to control the mixers 12 to pivot towards a second orientation. For example, at the second orientation, the first mixer 12 may be controlled to orient at −20°, the second mixer 12 may be controlled to orient at −10°, the third mixer 12 may be controlled to orient at the nominal angle. However, it is to be understood that the invention is not restricted to any particular angle or set of angles, but rather, includes any suitable angling schema.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A mixing apparatus for use with a vessel, comprising:
at least one mixer disposed proximal to a perimeter of the tank, said at least one mixer being operable to pivot or translate between a first position and a second position;
an actuator assembly connected to said at least one mixer, wherein said actuator operates to translate or pivot said at least one mixer between said first position and said second position;
a controller configured to control said actuator, wherein said controller operates to control translation of said at least one mixer between said first position and said second position.

2. The mixing apparatus according to claim 1, wherein said at least one mixer further comprises:
a motor assembly;
a drive shaft connected to said motor assembly
an impeller connected to said at drive shaft; and
a seal that allows said drive shaft to extend from said motor assembly through the vessel.

3. The mixing apparatus according to claim 1, wherein said actuator assembly is a pneumatic actuator.

4. The mixing apparatus according to claim 1, wherein said actuator assembly is a hydraulic actuator.

5. The mixing apparatus according to claim 1, wherein said actuator assembly is a linear thruster.

6. The mixing apparatus according to claim 1, further comprising a sensor assembly connected to said actuator assembly, wherein said sensor assembly is in communication with said controller and provides positioning data for said at least one mixer to said controller.

7. The mixing apparatus according to claim 6, wherein said sensor assembly comprises:
a sensor arm;
a sensor plate connected to said sensor arm;
a plurality of indicators disposed on said sensor plate; and
a plurality of indicators,
wherein said plurality of indicators and plurality of sensors cooperatively interact to determine the alignment of said at least one mixer.

8. The mixing apparatus according to claim 1, wherein said at least one mixer is a plurality of mixers disposed around the perimeter of the tank.

9. The mixing apparatus according to claim 8, further comprising a plurality of actuator assemblies wherein each of the plurality of mixers includes an actuator assembly connected thereto, wherein said actuator assembly operates to translate or pivot said at least one mixer between said first position and said second position.

10. The mixing apparatus according to claim 1, wherein each of the mixers comprises:
a motor assembly;
a drive shaft connected to said motor assembly
an impeller connected to said at drive shaft; and
a seal that allows said drive shaft to extend from said motor assembly through the vessel.

11. The mixing apparatus according to claim 9, wherein each actuator assembly is connected to a sensor assembly, each sensor assembly in communication with said controller and provides positioning data for said plurality of mixers to said controller.

12. The mixing apparatus according to claim 11, wherein each of said sensor assemblies comprises:
a sensor arm;
a sensor plate connected to said sensor arm;
a plurality of indicators disposed on said sensor plate; and
a plurality of indicators,
wherein said plurality of indicators and plurality of sensors cooperatively interact to determine the alignment of said plurality of mixers.

13. The mixing apparatus according to claim 9, wherein said actuator assembly is a pneumatic actuator.

14. The mixing apparatus according to claim 9, wherein said actuator assembly is a hydraulic actuator.

15. The mixing apparatus according to claim 9, wherein said actuator assembly is a linear thruster.

16. The mixing apparatus according to claim 1, further comprising a sensor assembly connected to said actuator assembly, wherein said sensor assembly is in communication with said controller and provides positioning data for said at least one mixer to said controller.

17. A method of translating or pivoting a at least one mixer in a vessel, the method comprising the steps of:
sending a position command from a control to an actuator assembly connected to the at least one mixer; and
translating the at least mixer from a first position to a second position in response to the position signal.

18. The method according to claim 17, further comprising the steps of:
receiving positioning data from a sensor assembly at the control;
sending a position command from the control in response to the positioning data received at the control; and
translating the at least on mixer in response to the positioning data received.

19. A mixing apparatus for use with a vessel, comprising:
means for sending a position command from a control to an actuator assembly connected to the at least one mixer; and
means for translating the at least mixer from a first position to a second position in response to the position signal;
means for receiving positioning data from a sensor assembly at the control;
means for sending a position command from the control in response to the positioning data received at the control; and
translating the at least on mixer in response to the positioning data received.

20. The mixing apparatus according to claim 19, wherein said at least one mixer is a plurality of mixers.
